(19) United States
(12) Patent Application Publication
(10) Pub. No.: US 2005/0086138 A1
(43) Pub. Date: Apr. 21, 2005

(54) Separate invoicing of private and service-related conversations on mobile telephones

(76) Inventor: Stefan Prange, Munchen (DE)

Correspondence Address: Siemens Corporation;Intellectual Property Department, 170 Wood Avenue South, Iselin, NJ, 08830, US

(21) Appl. No.: 10/500,593

(22) PCT Filed: Jan. 9, 2002
(86) PCT No.: PCT/DE02/00040

(51) Int. Cl. G06F 17/60

(52) U.S. Cl. 705/34

(57) ABSTRACT

According to the invention, ergonomic and efficient billing of service-related and private conversations can be achieved by a method of billing a conversation carried out by a user of a mobile radio terminal using said mobile radio terminal and a mobile radio network. According to the invention following an input of the user into the mobile radio terminal, indicating whether a conversation is to be billed as service-related or private, a message representing said input is sent to the mobile radio network.

### CROSS REFERENCE TO RELATED APPLICATIONS

This application is the US National Stage of International Application No. PCT/DE02/00040 filed Jan. 9, 2002 and claims the benefit thereof. The application is incorporated by reference herein in its entirety.

### FIELD OF INVENTION

The invention relates to methods and devices for billing a call made by a user of a mobile radio terminal via the mobile radio terminal and a mobile radio network.

### BACKGROUND OF INVENTION

Mobile radio terminals (mobile telephones/cell phones) are frequently used partly for private calls and partly for service-related calls, which for correct billing requires separate invoicing for private and service-related phone calls (voice calls and short messages, etc).

To date the problem has been solved in various ways. Firstly the customer could carry two mobile telephones with him, one for service-related calls and one for private calls, and hence receives two invoices. Furthermore it is possible to make service-related and private calls with one mobile radio terminal and to manually mark private calls and service-related calls on the monthly invoice, and where appropriate to settle up with the employer. Furthermore, mobile radio network operators offer a mobile radio card containing two mobile radio subscriber identities, making possible an invoice split up in accordance with the two mobile radio subscriber identities (and hence split up by service-related calls and private calls), but this requires that the telephone is switched off between a service-related call and a private call, and then switched on again, so that it can log on with the respective other mobile radio subscriber identity. Furthermore it is possible for a mobile radio subscriber to carry with him just one mobile telephone but two mobile radio subscriber identity cards and to swap these as appropriate. However, these approaches are inconvenient.

WO 92/19078 discloses a new logon of a mobile radio terminal with new identities (IMSI/MSISDN) on the instructions of a mobile radio subscriber in order to cause a billing for this new identity, and therefore does not require information to be transmitted as to whether a call is to be billed for a subscriber as service-related or private, to a mobile radio network or storage there of such information.

### SUMMARY OF INVENTION

The object of this invention is to permit separate billing and hence invoicing as ergonomically and efficiently as possible for private and service-related calls. The object is achieved in each case by the subject matters of the independent claims.

The invention very efficiently permits separate billing for private and service-related calls. To this end an entry made by a user of a mobile radio terminal is sent to a billing center of a mobile radio network operator before, after or during a call using for example a softkey (key assignable by software, or touchscreen, etc.) indicating the service-related or private nature of the current or last call by short message (SMS, MMS, IMS), USSD or in another manner. The statement contained in the message as to the private or service-related nature of the current or last call is here assigned to the other billing data (duration of call, international roaming charges, special tariffs, etc.; mobile radio subscriber identity MSISDN/IMSI, etc.). In the monthly invoice the indicator stored for this purpose as to whether the call was service-related or private can for each call made be used to include this call in the private or the service-related part of the invoice, so that at the end of the month the mobile radio terminal user receives an invoice divided into two parts showing his private and service-related calls, if appropriate with a corresponding pro-rata split of the basic subscription charges.

Further features and advantages of the invention are apparent from the following description of an exemplary embodiment on the basis of the drawing.

### BRIEF DESCRIPTION OF THE DRAWING

FIG. 1 schematically shows a mobile telecommunication network.

### DETAILED DESCRIPTION OF INVENTION

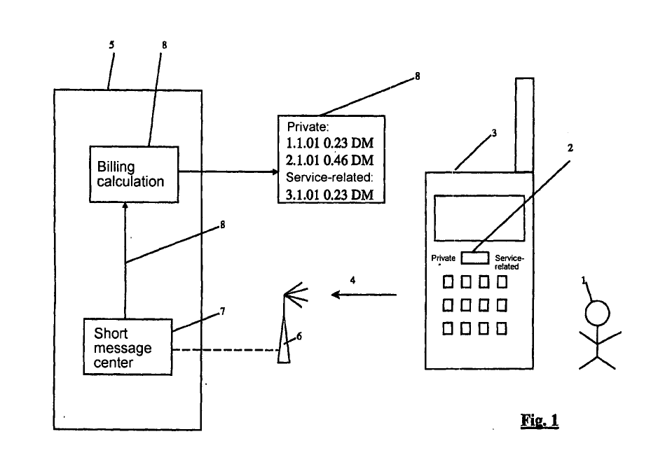

FIG. 1 shows a user 1 of a mobile radio terminal 3 having an entry key 3, via which mobile radio terminal 3 the subscriber 1 can make a call via the air interface 4 and a mobile radio network 5,6 indicated by a base station 6 to other users (not shown) of mobile radio terminals.

If the mobile radio terminal 3 (for example the S35 mobile telephone) has one or more softkeys 2 assignable by software, one or more softkeys can be assigned for entries by the user 1 of the terminal 3 concerning the service-related or private nature of the current or most recent call 4. The softkey can for example be a key on the entry keypad of the mobile telephone 3 in the form of a rocker with a left and right contact switch, whereby the right contact switch is assigned as “private” and the left contact switch as “service-related”. The service-related or private nature can for example be entered after keying in the directory number to be dialed by correspondingly pressing the entry key or entry keys 2. A message representing the service-related or private nature of the current or most recently made call can be sent by the mobile radio terminal 3 as a short message SMS, MMS, etc., USSD or in another manner to an address (for example a short message center 7) of the mobile radio network 5,6, from where it is forwarded to a billing calculation server 8 of the mobile radio network to enable the monthly charges to be calculated. Besides standard information (identity of the subscriber identity module in the mobile radio terminal 3, duration of the call, tariff, roaming charge, etc.), details of the service-related or private nature of the current or most recently made call are also stored in a list (billing record for this subscriber 1 or for his subscriber identity module) in the billing calculation server 8. The next time an (e.g. monthly) invoice is produced, the operator of the mobile radio network 5,6 splits the call charge information stored for a user 1 in the billing calculation center 8 in accordance with the information stored on the service-related or private nature and produces two part-invoices for service-related and private calls for the invoice for the mobile radio subscriber 1. In this case the basic subscription charge can also for example be split pro-rata or equally.

1-9. (canceled)

10. A method for billing a call made by a user of a mobile radio terminal via the mobile radio terminal and a mobile radio network, the method comprising:
determining, by the mobile radio terminal, an entry as to whether a call is to be billed as service-related or private;
sending a message representing the entry and the identity of a mobile radio subscriber identity module to the mobile radio network; and
storing information on the identity and information on the service-related or private nature of the call.

11. The method according to claim 10, wherein the call is a current or recently made call.

12. The method according to claim 10, wherein the message is a short message.

13. The method according to claim 10, wherein the message is a USSD.

14. The method according to claim 10, wherein the message comprises identity details concerning the mobile radio terminal user.

15. The method according to claim 10, wherein the message comprises an MSISDN or IMSI concerning the mobile radio terminal user.

16. The method according to claim 10, the method further comprising:
detecting an entry of a user before or during or after a call.

17. The method according to claim 10, the method further comprising:
assigning, by a billing computer, on the mobile radio network side data representing the entry to a call; and
taking into account the data for splitting the invoice into private and service-related calls the next time an invoice is produced.

18. A Mobile radio terminal, comprising
an assignable key; and
an apparatus for sending, when the key is actuated, a message to a mobile radio network regarding the service-related or private nature of a call made from the mobile radio terminal.

19. The mobile radio terminal according to claim 18, wherein the key is a softkey of the mobile radio terminal.

20. A mobile radio subscriber identity module for a mobile radio terminal, comprising:
an apparatus for sending, when an entry is made into a mobile radio terminal regarding the service-related or private nature of a call made from the mobile radio terminal, identity details representing the identity of the mobile radio subscriber identity module together with details representing the service-related or private nature of the call in a message to the mobile radio network.
